(19) United States
(12) Patent Application Publication
(10) Pub. No.: US 2024/0400731 A1
(43) Pub. Date: Dec. 5, 2024

(54) HDPE LPBM RESIN USING ADVANCED CHROME CATALYST BY POLYETHYLENE GAS PHASE TECHNOLOGY

(71) Applicant: Univation Technologies, LLC, Houston, TX (US)

(72) Inventors: Elva L. Lugo, Manvel, TX (US); Bo Liu, Pearland, TX (US); Mengmeng Li, Pearland, TX (US); Cliff R. Mure, Hillsbourough, NJ (US); Taylor L. Crammer, Charleston, WV (US); Francois Alexandre, Quebec (CA)

(73) Assignee: Univation Technologies, LLC, Houston, TX (US)

(21) Appl. No.: 18/692,171

(22) PCT Filed: Oct. 14, 2022
(86) PCT No.: PCT/US2022/078139

§ 371 Date: Mar. 14, 2024

Related U.S. Application Data
(60) Provisional application No. 63/256,317, filed on Oct. 15, 2021.

(51) Int. Cl. C08F 210/16

(52) U.S. Cl. CPC C08F 210/16

(57) ABSTRACT

According to one embodiment, a process for producing a unimodal ethylene/α-olefin copolymer, the process comprising contacting ethylene and one or more (C₃-C₁₂) α-olefin comonomers with a chromium-based catalyst system in a gas-phase polymerization reactor to produce the unimodal ethylene/α-olefin copolymer; wherein the unimodal ethylene/α-olefin copolymer comprises: a density from 0.952 g/cm³ to 0.957 g/cm³; a flow index (I₂₁) from 4.0 to 6.2 dg/min; a melt viscosity ratio (V_{0.1}/V₁₀₀) at 190° C. of 55 to 75; a molecular weight distribution (MWD) as calculated by the weight average molecular weight (M_{w}) divided by the number-average molecular weight (Mₙ) (M_{w}/Mₙ); and a peak molecular weight (Mₚ), all as measured by gel permeation chromatography.

### CROSS-REFERENCE TO RELATED APPLICATIONS

This application claims the benefit of U.S. Provisional Application Ser. No. 63/256,317 filed Oct. 15, 2021, the entire disclosure of which is hereby incorporated herein by reference.

### TECHNICAL FIELD

Embodiments of the present disclosure generally relate to high-density polyethylene (HDPE) resins for large part blow molding (LPBM); the processes to produce the resins, in which the processes include gas phase polymerization; and the articles produced from the HDPE resins.

### BACKGROUND

Large part blow molding articles include LPBM drums, which are a type of tight-head container that are generally between 200-220 liters in volume. They are made by a large-part blow molding process. They are designed primarily for the efficient transport of high value or hazardous materials, such as cosmetics, pharmaceuticals, and semi-conductor and electronics chemicals, and are intended for multiple use. Owing to the high value or hazardous nature of their contents, LPBM drums are required to meet United Nations and Department of Transportation (UN/DOT) specifications. To meet these UN/DOT specifications, the polyethylene resins used to make the LPBM drums must meet key performance requirements including melt strength, toughness, and stiffness.

Blow molding is one of the most effective ways to fabricate LPBM articles such as LPBM containers, such as the LPBM drums. Polyethylene is widely used for producing moldings of all types requiring a material with particularly high mechanical strength, high corrosion resistance, and reliable long-term stability. Another advantage of polyethylene is that it also has good chemical resistance and is intrinsically a light-weight material.

Accordingly, there may be a continual need for polyethylene compositions having good melt strength, toughness, and stiffness, as well as good processability.

### SUMMARY

Ongoing needs exist to create a polymer resin having good melt strength, toughness, and stiffness, as well as good processability. Embodiments of this disclosure include unimodal ethylene/α-olefin copolymers comprising polymerized units derived from ethylene. The unimodal ethylene/α-olefin polymer includes a density from 0.952 g/cm³ to 0.957 g/cm³ according to ASTM D1928; a flow index (I₂₁) from 4.0 to 6.2 dg/min, when measured according to ASTM D1238 at 190° C. and a 21.6 kg load; a melt viscosity ratio (V_{0.1}/V₁₀₀) at 190° C. greater than 55, where V_{0.1} is the viscosity of the ethylene/α-olefin polymer at 190° C. at a frequency of 0.1 radians/second, and V₁₀₀ is the viscosity of the ethylene/α-olefin polymer at 190° C. at a frequency of 100 radians/second; a molecular weight distribution (MWD) as determined by a conventional gel permeation chromatography method (GPC_{conv}) or an absolute gel permeation chromatography method (GPC_{abs}); a peak molecular weight (Mₚ) as determined by GPC_{conv} or GPC_{abs}; and a viscosity (V_{0.1}) at 190° C. at a frequency of 0.1 radians/second greater than or equal to 130,000.

Various embodiments of this disclosure include processes for producing ethylene/α-olefin copolymer. The process includes contacting ethylene and, optionally, one or more (C₃-C₁₂) α-olefin comonomers with a chromium-based catalyst system in a gas-phase polymerization reactor.

The ethylene-based copolymer produced by the processes of this disclosure include a density from 0.952 g/cm³ to 0.957 g/cm³ according to ASTM D792-13; a flow index (I₂₁) from 4.0 to 6.2 dg/min, when measured according to ASTM D1238 at 190° C. and a 21.6 kg load; a melt viscosity ratio (V_{0.1}/V₁₀₀) at 190° C. greater than 55 pascal-seconds, where V_{0.1} is the viscosity of the ethylene-based polymer at 190° C. at a frequency of 0.1 radians/second, and V₁₀₀ is the viscosity of the ethylene-based polymer at 190° C. at a frequency of 100 radians/second; a molecular weight distribution (MWD) greater than or equal to 25 as determined by a conventional gel permeation chromatography method; and a peak molecular weight (Mₚ) of less than 54,000 g/mol.

Embodiments of this disclosure include an article. The article includes the ethylene/α-olefin copolymer of this disclosure.

Other embodiments of this disclosure include the processes of blow molding a polyethylene/α-olefin copolymer, the processes comprising: melting the polyethylene/α-olefin copolymer according to this disclosure and then forming an article via blow molding.

Embodiments include a LPBM drum article comprising the unimodal ethylene/α-olefin copolymer according to this disclosure.

### DETAILED DESCRIPTION

The terms “ethylene/α-olefin polymer” or “polyethylene polymer” as used herein, refer to a polymer made of 100% ethylene-monomer units (a homopolymer) or refer to copolymers produced with other monomeric moieties, such as α-olefins (including, but not limited to, propylene, 1-butene, 1-pentene, 1-hexene, 1-octene, and so forth), wherein the copolymer comprises greater than 50% of its units from ethylene. Various polyethylene polymers are contemplated as suitable. For example and not by way of limitation, the polyethylene polymer may comprise HDPE.

The term “unimodal” refers a MWD in a GPC curve that exhibits a single component in the polymer resin.

Unless otherwise indicated values and ranges for molecular weights M_{w}, Mₙ, M_{z}, and Mₚ and values and ranges for MWD (M_{w}/Mₙ) have been measured according to the conventional GPC method described later (“GPC_{conv}”). Values and ranges for molecular weights M_{w}, Mₙ, M_{z}, and Mₚ and values and ranges for MWD (M_{w}/Mₙ) that are marked with “GPC_{abs}” or are said to be absolute GPC values and ranges have been measured by the absolute GPC method described later. Where there is a choice between using GPC_{conv} values and ranges and GPC_{abs} values and ranges to describe inventive embodiments, the GPC_{abs} values and ranges are preferred. If there would be a question of accuracy, especially for M_{w} and M_{z}, the GPC_{abs} values control.

### Polymerization Process

One or more embodiments of disclosure include a process for producing ethylene/α-olefin copolymer. The process includes contacting ethylene and, optionally, one or more (C₃-C₁₂) α-olefin comonomers with a chromium-based catalyst system in a gas-phase polymerization reactor.

The process of this disclosure produces the unimodal ethylene-based copolymer having a density from 0.952 g/cm³ to 0.957 g/cm³ according to ASTM D792-13; a flow index (I₂₁) from 4.0 to 6.2 dg/min, when measured according to ASTM D1238 at 190° C. and a 21.6 kg load; a melt viscosity ratio (V_{0.1}/V₁₀₀) at 190° C. greater than 55, where V_{0.1} is the viscosity of the ethylene-based polymer at 190° C. at a frequency of 0.1 radians/second, and V₁₀₀ is the viscosity of the ethylene-based polymer at 190° C. at a frequency of 100 radians/second; a molecular weight distribution (MWD) greater than or equal to 25 as determined by a conventional gel permeation chromatography method; and a peak molecular weight (Mₚ) of less than 56,000 g/mol.

In some embodiments the unimodal ethylene/α-olefin copolymer has a melt index (I₂) less than 0.15 g/10 min. measured at 190° C. and 2.16 kg according to ASTM D1238-13. Without being bound by theory, it is believed that a melt index (I₂) less than 0.15 g/10 min. is below the minimum value that may be reliably measured by ASTM D1238-13. This feature can distinguish the inventive unimodal ethylene/α-olefin copolymer from non-inventive unimodal ethylene/α-olefin copolymers that have a melt index (I₂) of greater than 0.15 g/10 min.

### Chromium-Based Catalysts System

In one or more embodiments, the chromium-based catalyst system may include chromium-based catalyst and a reducing agent.

In some embodiments, the chromium-based catalysts may include chromium oxide catalysts, silyl chromate catalysts, or a combination of both chromium oxide and silyl chromate catalysts.

The chromium compounds used to prepare chromium oxide catalysts may include CrO3 or any compound convertible to CrO3 under the activation conditions employed. Compounds capable of being converted into to CrO3 include chromic acetyl acetonate, chromic halide, chromic nitrate, chromic acetate, chromic sulfate, ammonium chromate, ammonium dichromate, or other soluble, chromium containing salts. In some embodiments, chromic acetate may be used.

In one or more embodiments, the reducing agent may comprise at least one of an alkylaluminum and an alkylaluminum alkoxide. In some embodiments the reducing agent is the alkylaluminum, such as a trialkylaluminum

The process for making the chromium-based catalyst system is discloses in International Published Application WO 2009/108174, which is incorporated herein in its entirety.

The inorganic oxide materials which may be used as a support in the catalyst compositions of the present disclosure are porous materials having variable surface area and particle size. In some embodiments, the support may have a surface area in the range of 50 to 1000 square meters per gram, and an average particle size of 20 to 300 micrometers. In some embodiments, the support may have a pore volume of about 0.5 to about 6.0 cm3/g and a surface area of about 200 to about 600 m2/g. In other embodiments, the support may have a pore volume of about 1.1 to about 1.8 cm3/g and a surface area of about 245 to about 375 m2/g. In some other embodiments, the support may have a pore volume of about 2.4 to about 3.7 cm3/g and a surface area of about 410 to about 620 m2/g. In yet other embodiments, the support may have a pore volume of about 0.9 to about 1.4 cm3/g and a surface area of about 390 to about 590 m2/g. Each of the above properties may be measured using conventional techniques as known in the art.

Activation of the supported chromium oxide catalyst can be accomplished at nearly any temperature from about 300° C. up to the temperature at which substantial sintering of the support takes place. For example, activated catalysts may be prepared in a fluidized-bed, as follows. The passage of a stream of dry air or oxygen through the supported chromium-based catalyst during the activation aids in the displacement of any water from the support and converts, at least partially, chromium species to Cr+6.

Temperatures used to activate the chromium-based catalysts are often high enough to allow rearrangement of the chromium compound on the support material. Peak activation temperatures of from about 300 to about 900° C. for periods of from greater than 1 hour to as high as 48 hours are acceptable. In some embodiments, the supported chromium oxide catalysts are activated at temperatures from about 400 to about 850° C., from about 500 to about 700° C., and from about 550 to about 650° C. Exemplary activation temperatures are about 600° C., about 700° C., and about 800° C. Selection of an activation temperature may take into account the temperature constraints of the activation equipment. In some embodiments, the supported chromium oxide catalysts are activated at a chosen peak activation temperature for a period of from about 1 to about 36 hours, from about 3 to about 24 hours, and from about 4 to about 6 hours. Exemplary peak activation times are about 4 hours and about 6 hours. Activation is typically carried out in an oxidative environment; for example, well dried air or oxygen is used and the temperature is maintained below the temperature at which substantial sintering of the support occurs. After the chromium compounds are activated, a powdery, free-flowing particulate chromium oxide catalyst is produced.

The cooled, activated chromium oxide catalyst may then be slurried and contacted with a reducing agent, fed at a selected feed rate over a selected time period, to result in a catalyst composition having a flow index response within a selected range. The solvent may then be substantially removed from the slurry to result in a dried, free-flowing catalyst powder, which may be fed to a polymerization system as is or slurried in a suitable liquid prior to feeding.

As noted above, the catalyst systems of the present disclosure may be utilized in processes for producing polymers, such as polyethylene, via the polymerization of olefins, such as ethylene. In embodiments, one or more olefins may be contacted with the catalyst systems of the present disclosure in a gas-phase polymerization reactor, such as a gas-phase fluidized bed polymerization reactor. Exemplary gas-phase systems are described in U.S. Pat. Nos. 5,665,818; 5,677,375; and 6,472,484; and European Patent Nos. 0 517 868 and 0 794 200. For example, in some embodiments, ethylene and, optionally, one or more (C₃-C₁₂)α-olefin comonomers may be contacted with the catalyst systems of the present disclosure in a gas-phase polymerization reactor. The catalyst system may be fed to the gas-phase polymerization reactor in neat form (i.e., as a dry solid. For example, the chromium-based catalyst may be fed into the reactor and the reducing agent may be added over a time period ranging from 5 seconds to greater than 5 second.

In embodiments, the gas-phase polymerization reactor comprises a fluidized bed reactor. A fluidized bed reactor may include a “reaction zone” and a “velocity reduction zone.” The reaction zone may include a bed of growing polymer particles, formed polymer particles, and a minor amount of the catalyst system fluidized by the continuous flow of the gaseous monomer and diluent to remove heat of polymerization through the reaction zone. Optionally, some of the re-circulated gases may be cooled and compressed to form liquids that increase the heat removal capacity of the circulating gas stream when readmitted to the reaction zone. A suitable rate of gas flow may be readily determined by simple experiment. Make up of gaseous monomer to the circulating gas stream may be at a rate equal to the rate at which particulate polymer product and monomer associated therewith may be withdrawn from the reactor and the composition of the gas passing through the reactor may be adjusted to maintain an essentially steady state gaseous composition within the reaction zone. The gas leaving the reaction zone may be passed to the velocity reduction zone where entrained particles are removed. Finer entrained particles and dust may be removed in a cyclone and/or fine filter. The gas may be passed through a heat exchanger where the heat of polymerization may be removed, compressed in a compressor, and then returned to the reaction zone. Additional reactor details and means for operating the reactor are described in, for example, U.S. Pat. Nos. 3,709,853; 4,003,712; 4,011,382; 4,302,566; 4,543,399; 4,882,400; 5,352,749; and 5,541,270; European Patent No. 0 802 202; and Belgian Patent No. 839,380.

In embodiments, the reactor temperature of the gas-phase polymerization reactor is from 30° C. to 150° C. For example, the reactor temperature of the gas-phase polymerization reactor may be from 30° C. to 120° C., from 30° C. to 110° C., from 30° C. to 100° C., from 30° C. to 90° C., from 30° C. to 50° C., from 30° C. to 40° C., from 40° C. to 150° C., from 40° C. to 120° C., from 40° C. to 110° C., from 40° C. to 100° C., from 40° C. to 90° C., from 40° C. to 50° C., from 50° C. to 150° C., from 50° C. to 120° C., from 50° C. to 110° C., from 50° C. to 100° C., from 50° C. to 90° C., from 90° C. to 150° C., from 90° C. to 120° C., from 90° C. to 110° C., from 90° C. to 100° C., from 100° C. to 150° C., from 100° C. to 120° C., from 100° C. to 110° C., from 110° C. to 150° C., from 110° C. to 120° C., or from 120° C. to 150° C. Generally, the gas-phase polymerization reactor may be operated at the highest temperature feasible, taking into account the sintering temperature of the polymer product within the reactor. Regardless of the process used to make the polyethylene, the reactor temperature should be below the melting or “sintering” temperature of the polymer product. As a result, the upper temperature limit may be the melting temperature of the polymer product.

In embodiments, the reactor pressure of the gas-phase polymerization reactor is from 690 kPa (100 psig) to 3,448 kPa (500 psig). For example, the reactor pressure of the gas-phase polymerization reactor may be from 690 kPa (100 psig) to 2,759 kPa (400 psig), from 690 kPa (100 psig) to 2,414 kPa (350 psig), from 690 kPa (100 psig) to 1,724 kPa (250 psig), from 690 kPa (100 psig) to 1,379 kPa (200 psig), from 1,379 kPa (200 psig) to 3,448 kPa (500 psig), from 1,379 kPa (200 psig) to 2,759 kPa (400 psig), from 1,379 kPa (200 psig) to 2,414 kPa (350 psig), from 1,379 kPa (200 psig) to 1,724 kPa (250 psig), from 1,724 kPa (250 psig) to 3,448 kPa (500 psig), from 1,724 kPa (250 psig) to 2,759 kPa (400 psig), from 1,724 kPa (250 psig) to 2,414 kPa (350 psig), from 2,414 kPa (350 psig) to 3,448 kPa (500 psig), from 2,414 kPa (350 psig) to 2,759 kPa (400 psig), or from 2,759 kPa (400 psig) to 3,448 kPa (500 psig).

In embodiments, hydrogen gas may be used in during polymerization to control the final properties of the polyethylene. The amount of hydrogen in the polymerization may be expressed as a mole ratio relative to the total polymerizable monomer, such as, for example, ethylene or a blend of ethylene and 1-hexene. The amount of hydrogen used in the polymerization process may be an amount necessary to achieve the desired properties of the polyethylene, such as, for example, melt flow rate (MFR). In embodiments, the mole ratio of hydrogen to total polymerizable monomer (H₂:monomer) is greater than 0.0001. For example, the mole ratio of hydrogen to total polymerizable monomer (H₂:monomer) may be from 0.0001 to 10, from 0.0001 to 5, from 0.0001 to 3, from 0.0001 to 0.10, from 0.0001 to 0.001, from 0.0001 to 0.0005, from 0.0005 to 10, from 0.0005 to 5, from 0.0005 to 3, from 0.0005 to 0.10, from 0.0005 to 0.001, from 0.001 to 10, from 0.001 to 5, from 0.001 to 3, from 0.001 to 0.10, from 0.10 to 10, from 0.10 to 5, from 0.10 to 3, from 3 to 10, from 3 to 5, or from 5 to 10.

In embodiments, the catalyst systems of the present disclosure may be utilized to polymerize a single type of olefin, producing a homopolymer. However, additional α-olefins may be incorporated into the polymerization scheme in other embodiments. The additional α-olefin comonomers typically have no more than 20 carbon atoms. For example, the catalyst systems of the present disclosure may be utilized to polymerize ethylene and one or more (C₃-C₁₂) α-olefin comonomers. Exemplary α-olefin comonomers include, but are not limited to, propylene, 1-butene, 1-pentene, 1-hexene, 1-heptene, 1-octene, 1-nonene, 1-decene, and 4-methyl-1-pentene. For example, the one or more α-olefin co-monomers may be selected from the group consisting of propylene, 1-butene, 1-hexene, and 1-octene; or, in the alternative, from the group consisting of 1-hexene and 1-octene.

In embodiments, the one or more (C₃-C₁₂) α-olefin comonomers may not be derived from propylene. That is, the one or more (C₃-C₁₂) α-olefin comonomers may be substantially free of propylene. The term “substantially free” of a compound means the material or mixture includes less than 1.0 wt. % of the compound. For example, the one or more (C₃-C₁₂) α-olefin comonomers, which may be substantially free of propylene, may include less than 1.0 wt. % propylene, such as less than 0.8 wt. % propylene, less than 0.6 wt. % propylene, less than 0.4 wt. % propylene, or less than 0.2 wt. % propylene.

### Unimodal Ethylene/α-Olefin Copolymer

In one or more embodiments of this disclosure, a unimodal ethylene/α-olefin copolymer comprising polymerized units derived from ethylene. The unimodal ethylene/α-olefin polymer includes a density from 0.952 g/cm³ to 0.957 g/cm³ according to ASTM D792-13; a flow index (I₂₁) from 4.0 to 6.2 dg/min, when measured according to ASTM D1238 at 190° C. and a 21.6 kg load; a melt viscosity ratio (V_{0.1}/V₁₀₀) at 190° C. greater than 55, where V_{0.1} is the viscosity of the ethylene/α-olefin polymer at 190° C. at a frequency of 0.1 radians/second, and V₁₀₀ is the viscosity of the ethylene/α-olefin polymer at 190° C. at a frequency of 100 radians/second; a molecular weight distribution (MWD) greater than or equal to 25 as determined by a conventional gel permeation chromatography method; a peak molecular weight (Mₚ) of less than 54,000 g/mol; and a viscosity (V_{0.1}) at 190° C. at a frequency of 0.1 radians/second greater than or equal to 130,000 pascal-seconds.

In some embodiments, the unimodal ethylene/α-olefin copolymer has a density in the range of 0.953-0.957 g/cm³; 0.953-0.956 g/cm³, or 0.954-0.956 g/cm³.

In various embodiments, the unimodal ethylene/α-olefin copolymer has a flow index (I₂₁) from 4.2 to 6.2; 4.7 to 5.7; or 5.0 to 5.4 when measured according to ASTM D1238 at 190° C.

In one or more embodiments, the unimodal ethylene/α-olefin copolymer has a melt viscosity ratio (V_{0.1}/V₁₀₀) at 190° C. from 55 to 75 or 55 to 69, where V_{0.1} is the viscosity of the ethylene/α-olefin polymer at 190° C. at a frequency of 0.1 radians/second, and V₁₀₀ is the viscosity of the ethylene/α-olefin polymer at 190° C. at a frequency of 100 radians/second. In some embodiments, the polyethylene/α-olefin copolymer has a melt viscosity ratio (V_{0.1}/V₁₀₀) at 190° C. greater than 57 to 71 or 51 to 69.

The “rheology ratio” and “melt viscosity ratio” are defined by V_{0.1}/V₁₀₀ at 190° C., where V_{0.1} is the viscosity of the unimodal ethylene/α-olefin copolymer at 190° C. at a frequency of 0.1 radians/second, and V₁₀₀ is the viscosity of the unimodal ethylene/α-olefin copolymer at 190° C. at an frequency of 100 radians/second.

In embodiments of this disclosure, the unimodal polyethylene/α-olefin copolymer has a viscosity (V_{0.1}) at 190° C. at a frequency of 0.1 radians/second of 130,000 pascal-seconds (pas·s) to 175,000 pas·s. In some embodiments, the viscosity (V_{0.1}) at 190° C. at a frequency of 0.1 radians/second of or 131,000 pas·s to 157,000 pas·s, 134,000 pas·s to 159,000 pas·s, or 138,000 pas·s to 148,000 pas·s.

In some embodiments, the unimodal the polyethylene/α-olefin copolymer has molecular weight distribution (MWD), as calculated by the weight average molecular weight (M_{w}) divided by the number-average molecular weight (Mₙ), of 25 to 35 or a molecular weight distribution of 25 to 32. The molecular weight distribution (MWD) is defined by the weight average molecular weight divided by the number average molecular weight (M_{w}/Mₙ). In various embodiments, the polyethylene/α-olefin copolymer has MWD of 26 to 30.

In various embodiments, the unimodal ethylene/α-olefin polymer may have a peak molecular weight, Mₚ, from 42,000 to 54,000 g/mol or 46,000 to 55,000 g/mol. The peak molecular weight, Mₚ, is the peak molecular weight of the ethylene/α-olefin polymer as determined from conventional gel permeation chromatography. In some embodiments, the unimodal ethylene/α-olefin copolymer has a Mₚ from 51,000 to 54,000 g/mol or 51,000 to 53,000 g/mol.

In one or more embodiments, the unimodal ethylene/α-olefin polymer may have a weight average molecular weight of greater than 340,000 g/mol. In some embodiments, the weight average molecular weight is from 340,000 to 440,000 g/mol, 350,000 to 440.00 g/mol, or 360,000 to 420,000 g/mol.

In one or more embodiments, the unimodal ethylene/α-olefin polymer may have molecular weight distribution in which greater than 14% by weight of the total composition has a weight-average molecular weight that is less than 10,000 g/mol.

In one or more embodiments, the unimodal ethylene/α-olefin polymer may have molecular weight distribution in which greater than 7% by weight of the total composition has a weight-average molecular weight that is greater than 1,000,000 g/mol.

In some embodiments, the unimodal the polyethylene/α-olefin copolymer has GPC_{abs} molecular weight distribution (GPC_{abs} MWD or GPC_{abs} M_{w}/Mₙ), as calculated by the GPC_{abs} weight average molecular weight (M_{w}) divided by the GPC_{abs} number-average molecular weight (Mₙ), of 25 to 35 or a molecular weight distribution of 25 to 32. The GPC_{abs} molecular weight distribution (GPC_{abs} MWD or GPC_{abs} M_{w}/Mₙ) is determined by absolute gel permeation chromatography. In various embodiments, the polyethylene/α-olefin copolymer has GPC_{abs} MWD of 26.1 to 29.9.

In various embodiments, the unimodal ethylene/α-olefin polymer may have a GPC_{abs} peak molecular weight, Mₚ, from 48,000 to 61,000 g/mol or 52,000 to 60,001 g/mol. The GPC_{abs} peak molecular weight, Mₚ, is the GPC_{abs} peak molecular weight of the ethylene/α-olefin polymer as determined from absolute gel permeation chromatography. In some embodiments, the unimodal ethylene/α-olefin copolymer has a GPC_{abs} Mₚ from 57,000 to 59,990 g/mol or 57,000 to 59,400 g/mol.

In one or more embodiments, the unimodal ethylene/α-olefin polymer may have a GPC_{abs} weight-average molecular weight of greater than 320,000 g/mol. In some embodiments, the GPC_{abs} weight-average molecular weight is from 320,000 to 400,000 g/mol, or from 330,000 to 400,000 g/mol, or from 340,000 to 380,000 g/mol.

In one or more embodiments, the unimodal ethylene/α-olefin polymer may have a GPC_{abs} molecular weight distribution in which greater than 14% by weight of the total composition has a GPC_{abs} weight-average molecular weight that is less than 10,000 g/mol.

In one or more embodiments, the unimodal ethylene/α-olefin polymer may have a GPC_{abs} molecular weight distribution in which greater than 7% by weight of the total composition has a GPC_{abs} weight-average molecular weight that is greater than 1,000,000 g/mol.

In various embodiments, the melt strength of the unimodal ethylene/α-olefin polymer of this disclosure may be greater than 30 cN (Rheotens device, 190° C., 2.4 mm/s², 120 mm from the die exit to the center of the wheels, extrusion rate of 38.2 s⁻¹, capillary die of 30 mm length, 2 mm diameter and 180° entrance angle). The high melt strength allows for better processability than other ethylene/α-olefin polymers having a lowing melt strength. The improved processability property means that the parison is more stable during the fabrication process, and thus less susceptible to sagging. In some embodiments, the unimodal ethylene/α-olefin copolymer further includes a melt strength from 31 cN to less than or equal to 50 cN. In some embodiments, the melt strength of is greater than or equal to 33 cN to 40 cN

In one or more embodiments, the unimodal ethylene/α-olefin copolymer further comprises a strain hardening modulus of greater than 21 MPa. In some embodiments, the strain hardening modulus is from 25 to 30 MPa.

In some embodiments, the unimodal ethylene/α-olefin copolymer includes an environmental stress cracking resistance (at 10% Igepal) greater than or equal to 320 hours. In various embodiments, the unimodal ethylene/α-olefin copolymer includes an environmental stress cracking resistance (at 10% Igepal) greater than or equal to 330 hours.

In embodiments, the ethylene/α-olefin polymer produced, for example homopolymers and/or interpolymers (including copolymers) of ethylene and, optionally, one or more comonomers may include at least 50 mole percent (mol. %) monomer units derived from ethylene. For example, the polyethylene may include at least 60 mol. %, at least 70 mol. %, at least 80 mol. %, or at least 90 mol. % monomer units derived from ethylene. In embodiments, the polyethylene includes from 50 mol. % to 100 mol. % monomer units derived from ethylene. For example, the polyethylene may include from 50 mol. % to 90 mol. %, from 50 mol. % to 80 mol. %, from 50 mol. % to 70 mol. %, from 50 mol. % to 60 mol. %, from 60 mol. % to 100 mol. %, from 60 mol. % to 90 mol. %, from 60 mol. % to 80 mol. %, from 60 mol. % to 70 mol. %, from 70 mol. % to 100 mol. %, from 70 mol. % to 90 mol. %, from 70 mol. % to 80 mol. %, from 80 mol. % to 100 mol. %, from 80 mol. % to 90 mol. %, or from 90 mol. % to 100 mol. % monomer units derived from ethylene.

In embodiments, the ethylene/α-olefin polymer produced includes at least 90 mol. % monomer units derived from ethylene. For example, the polyethylene may include at least 93 mol. %, at least 96 mol. %, at least 97 mol. %, or at least 99 mol. % monomer units derived from ethylene. In embodiments, the polyethylene includes from 90 mol. % to 100 mol. % monomer units derived from ethylene. For example, the polyethylene may include from 90 mol. % to 99.5 mol. %, from 90 mol. % to 99 mol. %, from 90 mol. % to 97 mol. %, from 90 mol. % to 96 mol. %, from 90 mol. % to 93 mol. %, from 93 mol. % to 100 mol. %, from 93 mol. % to 99.5 mol. %, from 93 mol. % to 99 mol. %, from 93 mol. % to 97 mol. %, from 93 mol. % to 96 mol. %, from 96 mol. % to 100 mol. %, from 96 mol. % to 99.5 mol. %, from 96 mol. % to 99 mol. %, from 96 mol. % to 97 mol. %, from 97 mol. % to 100 mol. %, from 97 mol. % to 99.5 mol. %, from 97 mol. % to 99 mol. %, from 99 mol. % to 100 mol. %, from 99 mol. % to 99.5 mol. %, or from 99.5 mol. % to 100 mol. % monomer units derived from ethylene.

In embodiments, the ethylene/α-olefin polymer produced includes less than 50 mol. % monomer units derived from an additional α-olefin. For example, the polyethylene may include less than 40 mol %, less than 30 mol. %, less than 20 mol. % or less than 10 mol. % monomer units derived from an additional α-olefin. In embodiments, the polyethylene includes from 0 mol. % to 50 mol. % monomer units derived from an additional α-olefin. For example, the polyethylene may include from 0 mol. % to 40 mol. %, from 0 mol. % to 30 mol. %, from 0 mol. % to 20 mol. %, from 0 mol. % to 10 mol. %, from 0 mol. % to 5 mol. %, from 0 mol. % to 1 mol. %, from 1 mol. % to 50 mol. %, from 1 mol. % to 40 mol. %, from 1 mol. % to 30 mol. %, from 1 mol. % to 20 mol. %, from 1 mol. % to 10 mol. %, from 1 mol. % to 5 mol. %, from 5 mol. % to 50 mol. %, from 5 mol. % to 40 mol. %, from 5 mol. % to 30 mol. %, from 5 mol. % to 20 mol. %, from 5 mol. % to 10 mol. %, from 10 mol. % to 50 mol. %, from 10 mol. % to 40 mol. %, from 10 mol. % to 30 mol. %, from 10 mol. % to 20 mol. %, from 20 mol. % to 50 mol. %, from 20 mol. % to 40 mol. %, from 20 mol. % to 30 mol. %, from 30 mol. % to 50 mol. %, from 30 mol. % to 40 mol. %, or from 40 mol. % to 50 mol. % monomer units derived from an additional α-olefin.

In embodiments, the unimodal ethylene/α-olefin polymer produced further includes one or more additives. Such additives include, but are not limited to, antistatic agents, color enhancers, dyes, lubricants, pigments, primary antioxidants, secondary antioxidants, processing aids, ultraviolet (UV) stabilizers, and combinations of these. The polyethylene may include any amounts of additives. In embodiments, the produced polyethylene further includes fillers, which may include, but are not limited to, organic or inorganic fillers, such as, for example, calcium carbonate, tale, or Mg(OH)₂.

The produced unimodal ethylene/α-olefin polymer may be used in a wide variety of products and end-use applications. The produced polyethylene may also be blended and/or co-extruded with any other polymer. Non-limiting examples of other polymers include linear low-density polyethylene (LLDPE), elastomers, plastomers, high pressure low density polyethylene, high density polyethylene, polypropylenes, and the like. The produced polyethylene and blends including the produced polyethylene may be used to produce blow-molded components or products, among various other end uses. The produced polyethylene and blends including the produced polyethylene may be useful in forming operations such as film, sheet, and fiber extrusion and co-extrusion as well as blow molding, injection molding and rotary molding. Films may include blown or cast films formed by coextrusion or by lamination useful as shrink film, cling film, stretch film, sealing films, oriented films, snack packaging, heavy duty bags, grocery sacks, baked and frozen food packaging, medical packaging, industrial liners, and membranes in food-contact and non-food contact applications. Fibers may include melt spinning, solution spinning and melt blown fiber operations for use in woven or non-woven form to make filters, diaper fabrics, medical garments, and geotextiles. Extruded articles may include medical tubing, wire and cable coatings, pipe, geomembranes, and pond liners. Molded articles may include single and multi-layered constructions in the form of bottles, LPBM drums, tanks, large hollow articles, rigid food containers and toys.

In one or more embodiments, an LPBM drum article comprising the unimodal ethylene/α-olefin copolymer according to this disclosure. In various embodiments, the unimodal ethylene/α-olefin copolymer has a density of 0.952 to 0.957 g/cm³.

Some embodiments of this disclosure include a process of blow molding a polyethylene/α-olefin copolymer. The process for blow molding may include melting the unimodal polyethylene/α-olefin copolymer according to this disclosure; and then forming an article via blow molding.

In one or more embodiments, the article is a LPBM drum.

### Test Methods

Polymerization Activity: Unless indicated otherwise, all polymerization activities (also referred to as productivities) presently disclosed were determined as a ratio of polymer produced to the amount of catalyst added to the reactor and are reported in grams of polymer per grams of catalyst per hour (gPE/gcat/hr).

Comonomer Content: Unless indicated otherwise, all comonomer contents (i.e., the amount of comonomer incorporated into a polymer) presently disclosed were determined by rapid FT-IR spectroscopy on dissolved polymer in a Gel Permeation Chromatography (GPC) measurement and are reported in weight percent (wt. %). The comonomer content of a polymer can be determined with respect to polymer molecular weight by use of an infrared detector, such as an IR5 detector, in a GPC measurement, as described in Lee et al., Toward absolute chemical composition distribution measurement of polyolefins by high-temperature liquid chromatography hyphenated with infrared absorbance and light scattering detectors, 86 ANAL. CHEM. 8649 (2014).

Uptake Ratio: Unless indicated otherwise, all uptake ratios presently disclosed were determined as a ratio of an amount of monomer units derived from a comonomer (e.g., a (C₃-C₁₂) α-olefin comonomer) to an amount of monomer units derived from ethylene.

Density: Density is measured according to ASTM D792-13, Standard Test Methods for Density and Specific Gravity (Relative Density) of Plastics by Displacement, Method B (for testing solid plastics in liquids other than water, e.g., in liquid 2-propanol). Report results in units of grams per cubic centimeter (g/cm³).

Flow Index or High Load Melt Index (HLMI) 121 Test Method: use ASTM D1238-13, Standard Test Method for Melt Flow Rates of Thermoplastics by Extrusion Platometer, using conditions of 190° C./21.6 kilograms (kg). Report results in units of grams eluted per 10 minutes (g/10 min.).

Melt Index (“I₂”) Test Method: for ethylene-based (co)polymer is measured according to ASTM D1238-13, using conditions of 190° C./2.16 kg, formerly known as “Condition E”. Report results in units of grams eluted per 10 minutes (g/10 min.).

Melt Index 15 (“I₅”) Test Method: use ASTM D1238-13, using conditions of 190° C./5.0 kg. Report results in units of grams eluted per 10 minutes (g/10 min.).

Melt Flow Ratio MFR2: (“I_{21/2}”) Test Method: calculated by dividing the value from the HLMI I₂₁ Test Method by the value from the Melt Index 12 Test Method.

Melt Flow Ratio MFR5: (“I_{21/5}”) Test Method: calculated by dividing the value from the HLMI I₂₁Test Method by the value from the Melt Index 15 Test Method.

### Dynamic Rheological Analysis

Dynamic oscillatory shear measurements are conducted over a range of 0.1 rad s−1 to 100 rad s−1 at a temperature of 190° C. and 10% strain with stainless steel parallel plates of 25 mm diameter on the strain controlled rheometer ARES/ARES-G2 by TA Instruments, to determine the melt flow properties of the ethylene-based polymers. V_{0.1} and V₁₀₀ are the viscosities at 0.1 and 100 rad s−1, respectively (with V_{0.1}/V₁₀₀ being a measure of shear thinning characteristics). Complex Shear Viscosity Test Method: determine rheological properties at 0.1 and 100 radians/second (rad/s) in a nitrogen environment at 190° C. and a strain of 10% in an ARES-G2 (TA Instruments) rheometer oven that is preheated for at least 30 minutes at 190° C. Place the disk prepared by the Compression Molded Plaque Preparation Method between two “25 mm” parallel plates in the oven. Slowly reduce the gap between the “25 mm” parallel plates to 2.0 mm. Allow the sample to remain for exactly 5 minutes at these conditions. Open the oven, and carefully trim excess sample from around the edge of the plates. Close the oven. Allow an additional 5-minute delay to allow for temperature equilibrium. Then determine the complex shear viscosity via a small amplitude, oscillatory shear, according to an increasing frequency sweep from 0.1 to 100 rad/s to obtain the complex viscosities at 0.1 rad/s and 100 rad/s. Define the shear viscosity ratio (SVR) as the ratio of the complex shear viscosity in pascal-seconds (Pa·s) at 0.1 rad/s to the complex shear viscosity in pascal-seconds (Pa·s) at 100 rad/s.

Melt Strength Test Method: Carried out Rheotens (Göttfert) melt strength experiments isothermally at 190° C. Produced a melt by a Göttfert Rheotester 2000 capillary rheometer, or Rheograph 25 capillary rheometer, paired with a Rheotens model 71.97, with a flat, 30/2 die at a shear rate of 38.2 s−1. Filled the barrel of the rheometer in less than one minute. Waited 10 minutes to ensure proper melting. Varied take-up speed of the Rheotens wheels with a constant acceleration of 2.4 mm/s². The die used for testing has a diameter of 2 mm, length of 30 mm and entry angle of 180 degrees. Load a test sample in pellet form into capillary barrel and allow it to melt and equilibrate at the testing temperature (190° C.) for 10 minutes to give a molten test sample. Then use the piston inside the barrel to apply a steady force on the molten test sample to achieve an apparent wall shear rate of 38.16 s⁻¹, and extrude the melt through the die with an exit velocity of approximately 9.7 mm/s. Located 100 mm below the die exit, guide the extrudate through wheel pairs (spaced 0.4 mm apart) of the rheometer, which both accelerate at a constant rate of 2.4 mm/s² and measure the extrudate's response to the applied extensional force. Display the test results as plots of force with respect to Rheotens wheel speed using the RtensEvaluations2007 Excel software. For analysis, the force at which fracture occurs in the melt is referred to as the melt strength of the material and the corresponding Rheotens wheel speed at fracture is considered the drawability limit. Monitored tension in the drawn strand over time until the strand broke. Calculated melt strength by averaging the flat range of tension.

Strain Hardening Modulus Test Method: The ISO 18488 standard is followed to determine strain hardening modulus (“SHM”). Resin pellets are compression molded into sheets of 0.3 mm thickness following molding conditions described in Table 1 of the ISO 18488 standard. After molding, the sheets are conditioned at 120° C. for one hour followed by controlled cooling at a rate of 2° C./min to room temperature. Five tensile bars (dog bone shaped) are punched out of the compression molded sheets. The tensile test is conducted in a temperature chamber at 80° C. Each specimen is conditioned for at least 30 minutes in the temperature chamber prior to starting the test. The test specimen is clamped top and bottom and a pre-load of 0.4 MPa with a speed of 5 mm/min is applied. During the test, the load and the elongation sustained by the specimen are measured. The test specimen is extended at a constant speed of 20 mm/min and data point are collected from a draw ratio (λ) of 8.0 until λ=12.0 or breakage. As specified in ISO 18488, the plot of true stress vs. draw ratio is used to calculate the slope between a draw ratio of 8.0 and 12.0. If failure occurred before a draw ratio of 12.0, then the draw ratio corresponding to the failure strain is considered as upper limit for the slope calculation. If failure occurred before a draw ratio of 8.0, then the test is considered invalid.

Environmental Stress Crack Resistance (ESCR) Test Method: ESCR measurements are conducted according to ASTM D1693-15, Standard Test Method for Environmental Stress-Cracking of Ethylene Plastics, Method B and ESCR (10% IGEPAL CO-630, F50) is the number of hours to failure of a bent, notched, compression-molded test specimen that is immersed in a solution of 10 weight percent IGEPAL CO-630 in water at a temperature of 50° C. Igepal CO-630 is an ethoxylated branched-nonylphenol of structural formula 4-(branched-C₉H₁₉)-phenyl-[OCH2CH2]ₙ—OH, wherein subscript n is a number such that the branched ethoxylated nonylphenol has a number-average molecular weight of about 619 grams/mole.

The above-described ESCR Test Method is used herein. For a more precise indication of stress-cracking resistance than that characterized by the above ESCR measured according to ASTM D1693-15, use instead Equivalent Stress-Cracking Resistance (EqSCR) determined by notched constant ligament stress (nCLS).

Equivalent Stress-Cracking Resistance (EqSCR) Test Method: EqSCR is determined by notched constant ligament stress (nCLS): Notched Constant Ligament Stress (nCLS) values at 600 psi actual pressure are based on ASTM F2136. The nCLS values were used as a more precise indication of performance than the Environmental Stress Crack Resistance (ESCR) based on ASTM D1693-15.

### Conventional Gel Permeation Chromatography Test Method (GPC_{conv}):

The chromatographic system consisted of a PolymerChar GPC-IR (Valencia, Spain) high temperature GPC chromatograph equipped with an internal IR5 infra-red detector (IR5) and 4-capillary viscometer (DV) coupled to a Precision Detectors (Now Agilent Technologies) 2-angle laser light scattering (LS) detector Model 2040. For all absolute Light scattering measurements, the 15 degree angle is used for measurement. The autosampler oven compartment was set at 165° Celsius and the column compartment and detectors were set at 155° Celsius. The columns used were 4 TOSOH TSKgel GMHHR-H (30) HT 30-micron particle size, mixed pore size columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. Individually prepared polystyrene standards of 10,000,000 and 15,000,000 g/mol, both from Agilent Technologies, were also prepared, at 0.5 and 0.3 mg/mL respectively. The polystyrene standards were pre-dissolved at 80° C. with gentle agitation for 30 minutes then cooled and the room temperature solution is transferred cooled into the autosampler dissolution oven at 160° C. for 30 minutes. The polystyrene standard peak molecular weights were converted to polyethylene molecular weights using Equation 1 (as described in Williams and Ward, J. Polym. Sci., Polym. Let., 6, 621 (1968)).:

$${M}_{polyethylene} = A \times {( {M}_{polystyrene} )}^{B} \qquad ( EQ 1 )$$

where M is the molecular weight, A has a value of 0.3992 and B is equal to 1.0.

A third order polynomial was used to fit the respective polyethylene-equivalent calibration points.

The total plate count of the GPC column set was performed with decane which was introduced into blank sample via a micropump controlled with the PolymerChar GPC-IR system. The plate count for the chromatographic system should be greater than 12,000 for the 4 TOSOH TSKgel GMHHR-H (30) HT 30-micron particle size, mixed pore size columns.

Samples were prepared in a semi-automatic manner with the PolymerChar “Instrument Control” Software, wherein the samples were weight-targeted at 1 mg/ml, and the solvent (contained 200 ppm BHT) was added to a pre nitrogen-sparged septa-capped vial, via the PolymerChar high temperature autosampler. The samples were dissolved for 3 hours at 165° Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 2-4, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ 2 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ 3 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} \qquad ( EQ 4 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate₍ₙₒₘᵢₙₐₗ₎) for each sample by RV alignment of the respective decane peak within the sample (RV_{(FM Sample)}) to that of the decane peak within the narrow standards calibration (RV_{(FM Calibrated)}). Any changes in the time of the decane marker peak are then assumed to be related to a linear-shift in flowrate (Flowrate_{(effective)}) for the entire run. After calibrating the system based on a flow marker peak, the effective flowrate (with respect to the narrow standards calibration) is calculated as Equation 5. Processing of the flow marker peak was done via the PolymerChar GPCOne™ Software. Acceptable flowrate correction is such that the effective flowrate should be within +/−0.5% of the nominal flowrate.

$$Flowrate ( effective ) = {Flowrate}_{( nominal )} * ( {RV}_{( F M Calibrated )} / {RV}_{( F M Sample )} ) \qquad ( EQ 5 )$$

### Absolute Gel Permeation Chromatography Test Method (GPC_{abs}): Triple Detector GPC (TDGPC)

For the determination of the viscometer and light scattering detector offsets from the IR5 detector, the Systematic Approach for the determination of multi-detector offsets is done in a manner consistent with that published by Balke, Mourey, et. al. (Mourey and Balke, Chromatography Polym. Chpt 12, (1992)) (Balke, Thitiratsakul, Lew, Cheung, Mourey, Chromatography Polym. Chpt 13, (1992)), optimizing triple detector log (MW and IV) results from a linear homopolymer polyethylene standard (3.5>Mw/Mn>2.2) with a molecular weight in the range of 115,000 to 125,000 g/mol to the narrow standard column calibration results from the narrow standards calibration curve using PolymerChar GPCOne™ Software.

The absolute molecular weight data was obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™ software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, dn/dc, of −0.104. Generally, the mass detector response (IR5) and the light scattering constant (determined using GPCOne™) should be determined from a linear standard with a molecular weight in excess of about 50,000 g/mole. The viscometer calibration (determined using GPCOne™) can be accomplished using the methods described by the manufacturer, or, alternatively, by using the published values of suitable linear standards, such as Standard Reference Materials (SRM) 1475a (available from National Institute of Standards and Technology (NIST)). A viscometer constant (obtained using GPCOne™) is calculated which relates specific viscosity area (DV) and injected mass for the calibration standard to its intrinsic viscosity. The chromatographic concentrations are assumed low enough to eliminate addressing 2nd viral coefficient effects (concentration effects on molecular weight).

The absolute weight average molecular weight (MW_{(Abs)}) is obtained (using GPCOne™) from the Area of the Light Scattering (LS) integrated chromatogram (factored by the light scattering constant) divided by the mass recovered from the mass constant and the mass detector (IR5) area. The molecular weight and intrinsic viscosity responses are linearly extrapolated at chromatographic ends where signal to noise becomes low (using GPCOne™). Other respective moments, Mn_{(Abs)} and Mz_{(Abs)} are be calculated according to equations 8-10 as follows:

$${Mn}_{( Abs )} = \frac{{\sum }^{i} {IR}_{i}}{{\sum }^{i} ( {IR}_{i} / {M}_{{Absolute}_{i}} )} \qquad ( EQ 8 )$$

$${Mw}_{( Abs )} = \frac{{\sum }^{i} {IR}_{i} \times {M}_{{Absolute}_{i}}}{{\sum }^{i} {IR}_{i}} \qquad ( EQ 9 )$$

$${Mz}_{( Abs )} = \frac{{\sum }^{i} ( {IR}_{i} * {M}_{{Absolute}_{i}}^{2} )}{{\sum }^{i} ( {IR}_{i} * {M}_{{Absolute}_{i}} )} \qquad ( EQ 10 )$$

### Production of Catalyst

Catalysts employed in the Inventive Examples 1, specifically those using C₃₅₃₀₀MSF chromium on silica support, were prepared on a commercial scale as follows. About 698.5 kg (1540 pounds) of a porous silica support containing about 5 weight percent chromium acetate (Grade C₃₅₃₀₀MSF chromium on silica, produced by PQ Corporation), which amounts to about 1 weight percent Cr content, having a particle size of about 90 microns and a surface area of about 500 square meters per gram was charged to a fluidized bed heating vessel. There it was heated slowly at a rate of about 50° C. per hour under dry nitrogen up to 200° C. and held at that temperature for about 4 hours. Next it was heated slowly at a rate of about 50° C. per hour under dry nitrogen up to 450° C. and held at that temperature for about 2 hours. The nitrogen stream was then replaced with a stream of dry air and the catalyst composition was heated slowly at a rate of about 50° C. per hour to 600° C. where it was activated for about 6 hours. The activated catalyst was then cooled with dry air (at ambient temperature) to about 300° C. and further cooled from 300° C. to room temperature with dry nitrogen (at ambient temperature). The resulting cooled powder was stored under nitrogen atmosphere until treated with a reducing agent as described below.

In a typical chromium oxide catalyst reduction, the catalyst was placed in a vertical catalyst blender with a helical ribbon agitator under an inert atmosphere. Degassed and dried hexane or isopentane solvent was added to adequately suspend the supported catalyst. For catalysts using C35300MSF starting material in the Examples, about 7.1 liters of solvent were charged per kilogram (0.89 gallons per pound) of support. DEALE, available from Nouryon, and obtained as a 25 wt % solution in isopentane or hexane, was then added to the surface of the catalyst slurry at a selected rate over a selected time period to obtain a selected molar ratio of DEALE/Cr. The mixture was agitated at a selected agitation rate at a temperature of approximately 45° C. during the selected addition time. The mixture was further agitated at a controlled rate for about 2 hours. Then the solvent was substantially removed by drying at a jacket temperature of approximately 70° C. and slightly above atmospheric pressure for about 18 hours. The resulting dry, free flowing powder was then stored under nitrogen until used.

Catalysts employed in the Comparative Examples 1, specifically those using a silyl chromate compound on silica support, were prepared on a commercial scale as follows. About 1116 kg (2460 pounds) of porous silica support (Grade Sylopol 955 chromium on silica, produced by Davison Catalyst division of W. R. Grace and Co.), having a particle size of about 40 microns and a surface area of about 300 square meters per gram was charged to a fluidized bed heating vessel. There it was heated slowly at a rate of about 100° C. per hour under dry nitrogen up to 325° C. and the nitrogen stream was then replaced with a stream of dry air. The silica support was heated slowly at a rate of about 100° C. per hour to 600° C. where it was activated for about 1.5 hours. The calcined support was then cooled with dry air (at ambient temperature) to about 300° C. and further cooled from 300° C. to room temperature with dry nitrogen (at ambient temperature). The resulting cooled powder was stored under nitrogen atmosphere until treated with a chromium compound and then a reducing agent as described below.

In supporting the silyl chromate compound on the silica, the support was placed in a vertical catalyst blender with a helical ribbon agitator under an inert atmosphere. For catalysts in the Examples, about 5.8 liters of isopentane solvent were charged per kilogram (0.70 gallons per pound) of silica. The resulting mixture was stirred and heated to about 45° C. Then 3.15 kilograms of bis(triphenylsilyl) chromate was charged for every 100 kilograms of silica. This was stirred at about 45° C. for 10 hours. A 25 wt % solution of DEALE in isopentane was then added to the surface of the catalyst slurry at a selected rate over a selected time period to obtain a selected molar ratio of DEALE/Cr. The mixture was agitated at a selected agitation rate at a temperature of approximately 45° C. during the selected addition time. The mixture was further agitated at a selected rate for about 2 hours. Then the solvent was substantially removed by drying at a jacket temperature of approximately 75° C. and slightly above atmospheric pressure for about 24 hours. The resulting dry, free flowing powder was then stored under nitrogen until used.

### Production of Polyethylene

ACCLAIM™ K-100 series catalyst was utilized for polymerization. For the polymerization, a gas phase fluidized bed reactor was used which had a 0.57 m internal diameter and 4.0 m bed height and a fluidized bed composed of polymer granules. Fluidization gas was passed through the bed at a velocity of 1.8 to 2.2 ft/s. The fluidization gas exited the top of the reactor and passed through a recycle gas compressor and heat exchanger before re-entering the reactor below a distribution grid. A constant fluidized bed temperature was maintained by continuously adjusting the temperature of water on the shell side of a shell-and-tube heat exchanger. Gaseous feed streams of ethylene (monomer), nitrogen and hydrogen together with 1-hexene (comonomer) were introduced into a recycle gas line. The reactor was operated at a total pressure of approximately 2068 kPa gauge and vented to a flare to control pressure. Individual flow rates of ethylene, nitrogen, hydrogen and 1-hexene were adjusted to maintain desired targets. Concentrations of all gasses were measured using an on-line gas chromatograph. The catalyst was fed semi-continuously at a rate to achieve a targeted polymer production rate in the range of 50 to 60 lbs/hour. The fluidized bed was maintained at constant height by withdrawing a portion of the bed at a rate equal to the rate of formation of product. Product was removed semi-continuously via a series of valves into a fixed volume chamber. A nitrogen purge removed a significant portion of entrained and dissolved hydrocarbons in the fixed volume chamber. The product was further treated with a small stream of humidified nitrogen to deactivate any trace quantities of residual catalyst and/or cocatalyst. Polymerization conditions and/or product properties are reported in Table 1.

The reaction conditions used for each run are reported in Table 1. The properties of the poly(ethylene-co-1-hexene) copolymer produced by each run are reported in Tables 2 and 3.

TABLE 1
Reaction conditions

| | | Polyethylene | Polyethylene |
|---|---|---|---|
| Part # | | Composition 1 | Composition 2 |
| Reaction Configuration | | Single | Single |
| Reactor Temperature | (° C.) | 100.5 | 99.0 |
| Reactor Pressure | (psig) | 350 | 350 |
| Recycle Gas Velocity | (ft/sec) | 1.8 | 1.8 |
| Ethylene Partial Pressure * | (psi) | 200 | 200 |
| H2/C2 Ratio ** | (mol/mol) | 0.011 | 0.011 |
| C6/C2 Ratio *** | (mol/mol) | 0.0013 | 0.0013 |
| O2 Addback | (ppbv) | 95 | 115 |
| Residence Time | Hrs | 2.1 | 2.1 |

TABLE 2

| Sample | Density | I₂₁ | | | | | | V_{0.1} | V_{0.1}/ |
|---|---|---|---|---|---|---|---|---|---|
| Description | g/cm³ | g/10 min | Mn | Mw | Mz | Mw/Mn | Mp | Pa s | V₁₀₀ |
| Inventive Example | 0.955 | 5.2 | 14,144 | 389,417 | 3,703,293 | 27.5 | 52,678 | 142,595 | 64 |
| Comparative C1 | 0.956 | 5.0 | 17,698 | 346,211 | 3,167,207 | 19.6 | 57,401 | 127,049 | 53 |
| Comparative C2 | 0.954 | 7.2 | 12,839 | 319,432 | 3,676,154 | 24.9 | 58,242 | 102,958 | 51 |

Absolute GPC Data

| Sample Description | Mn | Mw | Mz | Mw/Mn | Mp |
|---|---|---|---|---|---|
| GPC Method | GPC_{abs} | GPC_{abs} | GPC_{abs} | GPC_{abs} | GPC_{abs} |
| Inventive Example | 12,455 | 348,138 | 2,343,836 | 27.9 | 58,886 |
| Comparative C1 | 15,300 | 309,360 | 2,009,570 | 20.2 | 66,063 |
| Comparative C2 | 14,295 | 282,534 | 1,722,781 | 19.8 | 64,565 |

TABLE 3

| | ESCR (10%) | Melt Strength | SHM |
|---|---|---|---|
| Sample Description | hrs | 190° C. cN | MPa |
| Inventive Example | 340 | 35 | 26.5 |
| Comparative C1 | 180 | 30 | 20.3 |
| Comparative C2 | 309 | 20 | 19.0 |

As previously described, the processability is often inversely related to the end-use performance of a drum, meaning that the more processable the resin is, the less capable the resin is at withstanding end-use factors (such as stress and chemical exposure). Therefore, the processability results and the end-use performance results of the Inventive Example were compared to the processability results and the end-use performance results of the Comparative C1 resin and the Comparative C2. Comparative C1 resin and Comparative C2 resin are commercial resins used to make LPBM drums.

The processability parameters used to test the Inventive Example and the Comparative C1 and C2 resins included melt strength, melt flow (I₂₁), viscosity ratio (V_{0.1}/V₁₀₀), and density. The Inventive Example had a higher viscosity ratio, higher melt strength, and a comparable melt flow when compared to the Comparative C1 resin and the Comparative C2 resin.

Additionally, the Inventive example had very good end-use performance results. To study the end-use performance results, the resin of the Inventive example was subjected to the Environmental Stress Crack Resistance test at 10% and the strain hardening modulus. In each of these tests, the Inventive Example had an increase in performance when compared to the Comparative C1 resin and the Comparative C2 resin.

1. A process for producing a unimodal ethylene/α-olefin copolymer, the process comprising contacting ethylene and one or more (C₃-C₁₂) α-olefin comonomers with a chromium-based catalyst system in a gas-phase polymerization reactor to produce the unimodal ethylene/α-olefin copolymer;
wherein the unimodal ethylene/α-olefin copolymer comprises:
a density from 0.952 g/cm³ to 0.957 g/cm³ according to ASTM D 792-13;
a flow index (I₂₁) from 4.0 to 6.2 dg/min, when measured according to ASTM D1238 at 190° C. and a 21.6 kg load;
a melt viscosity ratio (V_{0.1}/V₁₀₀) at 190° C. of 55 to 75, where V_{0.1} is the viscosity of the unimodal ethylene/α-olefin copolymer at 190° C. at a frequency of 0.1 radians/second, and V₁₀₀ is the viscosity of the unimodal ethylene/α-olefin copolymer at 190° C. at a frequency of 100 radians/second;
a GPC_{abs} molecular weight distribution (MWD) as calculated by the GPC_{abs} weight average molecular weight (Mw) divided by the GPC_{abs} number-average molecular weight (Mn) (M_{w}/Mₙ), from 25 to 35 as determined by an absolute gel permeation chromatography method; and
a GPC_{abs} peak molecular weight (Mₚ) of from 48,000 g/mol to less than 61,000 g/mol.

2. The process of claim 1, wherein:
the density is in the range of 0.953-0.957 g/cm³;
the flow index (I₂₁) is from 4.2 to 6.2 dg/min;
the melt viscosity ratio (V_{0.1}/V₁₀₀) at 190° C. is from 55 to 69;
the GPC_{abs} molecular weight distribution (MWD) as calculated by the GPC_{abs} weight average molecular weight (Mw) divided by the GPC_{abs} number-average molecular weight (Mn) (M_{w}/Mₙ), is from 25 to 32; and
the GPC_{abs} peak molecular weight (Mₚ) is from 48,000 to 60,000 g/mol.

3. The process of claim 1, wherein the unimodal ethylene/α-olefin copolymer has a viscosity (V_{0.1}) at 190° C. at a frequency of 0.1 radians/second from 130,000 to 175,000 pascal-seconds.

4. The process of claim 1, wherein the (C₃-C₁₂) α-olefin comonomer is 1-hexene.

5. The process of claim 1, wherein the chromium-based catalyst system comprises from 0.50 to 1.00 wt. % chromium based on the total weight of the chromium-based catalyst system.

6. The process of claim 1, wherein the chromium-based catalyst comprises from 1.00 to 2.00 wt. % of aluminum, based on the total weight of the chromium-based catalyst system.

7. The process of claim 1, wherein the chromium-based catalyst system comprises a reducing agent.

8. A unimodal ethylene/α-olefin copolymer comprising polymerized units derived from ethylene and a (C₃-C₁₂) α-olefin comonomer, wherein the unimodal ethylene/α-olefin copolymer comprises:
a density from 0.952 g/cm³ to 0.957 g/cm³ according to ASTM D 792-13;
a flow index (I₂₁) from 4.0 to 6.2 dg/min, when measured according to ASTM D1238 at 190° C. and a 21.6 kg load;
a melt viscosity ratio (V_{0.1}/V₁₀₀) at 190° C. greater than 55, where V_{0.1} is the viscosity of the ethylene/α-olefin copolymer at 190° C. at a frequency of 0.1 radians/second, and V₁₀₀ is the viscosity of the ethylene/α-olefin copolymer at 190° C. at a frequency of 100 radians/second; and
a GPC_{abs} molecular weight distribution (MWD) greater than or equal to 25 as calculated by the GPC_{abs} weight average molecular weight (Mw) divided by the GPC_{abs} number-average molecular weight (Mn), (M_{w}/Mₙ), as determined by an absolute gel permeation chromatography method;
a GPC_{abs} peak molecular weight (Mₚ) of less than 61,000 g/mol; and
a viscosity (V_{0.1}) at 190° C. at a frequency of 0.1 radians/second greater than or equal to 130,000 pascal-seconds.

9. The unimodal ethylene/α-olefin copolymer of claim 8, wherein:
the density is in the range of 0.953-0.957 g/cm³;
the flow index (I₂₁) is from 4.2 to 6.2 dg/min;
the melt viscosity ratio (V_{0.1}/V₁₀₀) at 190° C. is greater than 55 to 75;
the GPC_{abs} molecular weight distribution (MWD) is 25 to 35;
the viscosity (V_{0.1}) at 190° C. at a frequency of 0.1 radians/second is 130,000 to 175,000 pascal-seconds; and
the GPC_{abs} peak molecular weight (Mₚ) is from 48,000 to 60,000 g/mol.

10. The unimodal ethylene/α-olefin copolymer of claim 8, wherein the unimodal ethylene/α-olefin copolymer further comprises a strain hardening modulus of greater than 21 MPa.

11. The unimodal ethylene/α-olefin copolymer of claim 8, wherein the unimodal ethylene/α-olefin copolymer further comprises an environmental stress cracking resistance (at 10% Igepal) greater than or equal to 320 hours.

12. The unimodal ethylene/α-olefin copolymer of claim 8, wherein the unimodal ethylene/α-olefin copolymer further comprises a melt strength of greater than 30 cN to less than or equal to 50 cN.

13. A fabricated article comprising the unimodal ethylene/α-olefin copolymer according to claim 1.

14. The fabricated article of claim 13, wherein the unimodal ethylene/α-olefin copolymer has a density of 0.952 g/cm³ to 0.955 g/cm³.

15. A process of blow molding a unimodal ethylene/α-olefin copolymer into a blow-molded article, the process comprising:
melting the unimodal ethylene/α-olefin copolymer according to claim 1 to give a melt thereof;
extruding the melt into a mold to form a shape; and
injecting a gas into the mold to create a cavity within the shape, thereby making the blow-molded article.
